(19) United States
(12) Patent Application Publication
(10) Pub. No.: US 2016/0360729 A1
(43) Pub. Date: Dec. 15, 2016

(54) MULTIFUNCTIONAL CAT CONDO

(71) Applicant: JIANGSU FAVORITE LEISURE ARTICLES CO., LTD., Jiangsu (CN)

(72) Inventor: Hao SHI, Jiangsu (CN)

(73) Assignee: JIANGSU FAVORITE LEISURE ARTICLES CO., LTD., Jiangsu (CN)

(21) Appl. No.: 15/172,094

(22) Filed: Jun. 2, 2016

(30) Foreign Application Priority Data
Jun. 2, 2015 (CN) 201520373913.8

(51) Int. Cl. A01K 15/02; A01K 29/00

(52) U.S. Cl. CPC A01K 15/025; A01K 29/005

(57) ABSTRACT

A multifunctional cat condo has a three-layered structure, wherein both the bottom layer and the second layer comprise resting houses, and the top layer comprises a resting ledge, wherein the two resting houses and the resting ledge are connected through a plurality of vertical posts and are suspended on a bottom board, wherein climbing boards are connected between the resting house in the bottom layer and the ground as well as between the two resting houses; and an inside of the resting house is provided with a wireless camera that can communicate with an external control terminal and is configured to send activity situations of the cat in the resting house to the control terminal; an inside of the vertical post is provided with a music sounder; and a bottom end of one of the plurality of vertical posts is provided with a pressure sensor.

### CROSS-REFERENCE TO RELATED APPLICATIONS

This application claims the priority of Chinese Patent Application No. 201520373913.8, filed on Jun. 2, 2015, the disclosure of which is incorporated by reference in its entirety.

### TECHNICAL FIELD

The invention relates to a pet product, and more particularly, to a multifunctional cat condo.

### BACKGROUND ART

With the social progress and increasing living standards, pets have also become a part of life of people. However, household living space in a city is increasingly cramped. As a result, the activity space for pets is also increasingly smaller. While the pets, and more particularly the cats, are active by nature.

Cat is a kind of animal that hide in the daytime and comes out at night, with little movements. More particularly, a household pet cat moves less. In order to make the household pet cat healthier and more active, a cat condo emerges at the right moment, which creates a space where the cat can enjoy playing. Present cat condos are generally multi-layer structures, but their functions are relatively simple. The cat condos can be used only for resting and climbing, which are not interesting, and cats can easily get bored.

### SUMMARY OF THE INVENTION

An object of the invention is to provide a multifunctional cat condo, which is highly interesting and also has photographing and sounding functions, in view of the foregoing problems.

An object of the invention may be implemented as follows.

The invention relates to a multifunctional cat condo, wherein the cat condo is a three layer structure, wherein both the bottom layer and the second layer are resting houses, and the top layer is a resting ledge, the two resting houses and the resting ledge are connected through a plurality of vertical posts and are suspended on a bottom board, and climbing boards are connected between the resting house in the bottom layer and the ground as well as between the two resting houses.

The inside of the resting house is provided with a wireless camera that can be communicated with an external control terminal and is configured to send the activity situations of the cat in the resting house to the control terminal. The inside of the vertical post is provided with a music player (sounder); and the bottom end of one of the plurality of vertical posts is provided with a pressure sensor.

Wherein, the resting houses, the resting ledge, the vertical posts and the climbing boards are all coated with cotton and lint.

Wherein, both the bottom surfaces of the resting houses and the resting ledge are provided with a heating mechanism.

Wherein, the heating mechanism is a heating filament, and the heating filament is coated in the cotton that covers the bottom surfaces of the resting houses and the resting ledge.

Wherein, the bottom of the resting ledge is connected, through an elastic rope, with a play article, and the play article is located above the resting house on the bottom layer.

Embodiments of the invention has one or more of the following advantageous effects: the cat condo is configured in multi-layers, which can satisfy the active and climbing behaviors of the cat, to provide a preferable platform for the cat to play, and can provide the cat with multi-functions like playing, resting and keeping warm.

### BRIEF DESCRIPTION OF THE DRAWINGS

FIG. 1 is a structure diagram of one embodiment of the invention.

FIG. 2 is a structural drawing of bottom surfaces of resting houses and a resting ledge in accordance with one embodiment of the invention.

### DETAILED DESCRIPTION

Embodiments of the invention will be further described in details hereinafter with reference to the drawings and specific examples.

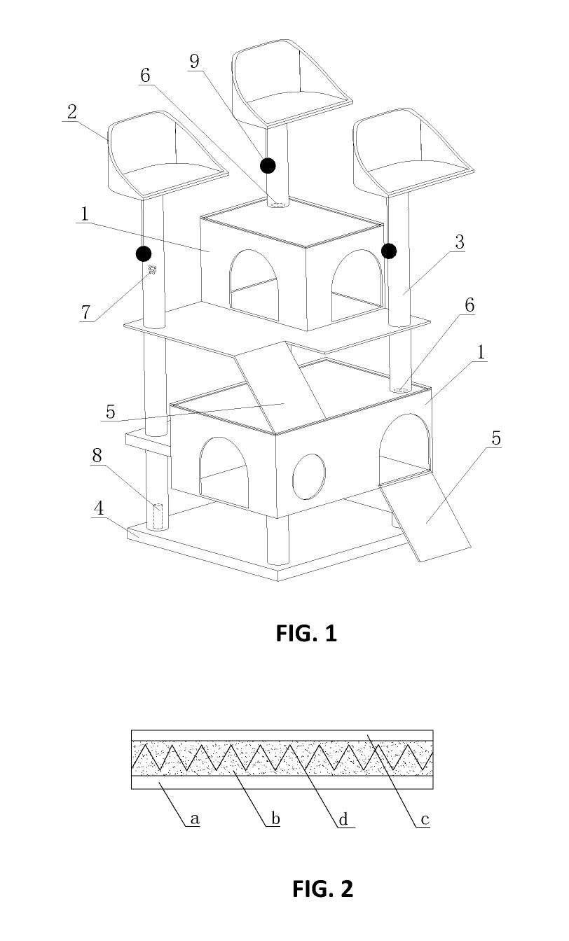

As shown in FIG. 1, a cat condo is a three-layered structure, wherein both the bottom layer and the second layer comprise resting houses 1, and the top layer comprises a resting ledge 2. The two resting houses 1 and the resting ledge 2 are connected through a plurality of vertical posts 3 and are suspended on a bottom board 4. Climbing boards 5 are connected between the resting house 1 in the bottom layer and the ground as well as between the two resting houses 1.

The inside of the resting house 1 is provided with a wireless camera 6 that can communicate with an external control terminal, and is configured to send the activity situations of the cat in the resting house 1 to the control terminal. Wherein, the control terminal may be a smartphone or a tablet, and a master (pet owner) may view the situation of the cat in the resting house 1 in real time via the smartphone or the tablet. The inside of the vertical post 3 is provided with a music sounder (player) 7, and the bottom end of one of the plurality of vertical posts 3 is provided with a pressure sensor 8. When the cat climbs the cat condo to make the pressure sensor 8 bear force, the music sounder 7 will produce a music sound so as to increase the attractiveness of the cat condo to the cat.

The resting houses 1, the resting ledge 2, the vertical posts 3 and the climbing boards 5 are all covered with cotton and/or lint, so that the cat condo is more comfortable, thereby implementing the function of a battery. Both the bottom surfaces of the resting houses 1 and the resting ledge 2 may be provided with a heating mechanism, which can improve the warmth of the cat in a cold winter, further improving the comfort level of the cat condo. To be specific, the heating mechanism is a heating filament d, wherein the heating filament is coated in the cotton b covering the bottom surfaces of the resting houses 1 and the resting ledge 2. As shown in FIG. 2, the bottom layer a is the bottom surface of the resting house 1 and the resting ledge 2, the middle is the cotton b, the top layer is the lint c, and the heating filament d is coated in the cotton b. The structure can prevent the cat from electric shock, so that the cat condo is safer. While for preventing the cat from being scalded due to superheating of the heating mechanism, the heating mechanism is also connected with a temperature control switch so as to improve the safety.

In order to increase the interesting property of the cat condo, the bottom of the resting ledge 2 is connected with a funny article 9 through an elastic rope, wherein the funny article 9 is located above the resting house 1 in the bottom layer.

What is claimed is:

1. A multifunctional cat condo, characterized in that the cat condo is a three-layered structure, wherein both the bottom layer and the second layer comprise resting houses, and the top layer comprises a resting ledge, wherein the two resting houses and the resting ledge are connected through a plurality of vertical posts and are suspended on a bottom board, wherein climbing boards are connected between the resting house in the bottom layer and the ground as well as between the two resting houses; and
an inside of the resting house is provided with a wireless camera that can communicate with an external control terminal and is configured to send activity situations of the cat in the resting house to the control terminal; an inside of the vertical post is provided with a music sounder; and a bottom end of one of the plurality of vertical posts is provided with a pressure sensor.

2. The multifunctional cat condo according to claim 1, wherein the resting houses, the resting ledge, the vertical posts and the climbing boards are all covered with cotton and/or lint.

3. The multifunctional cat condo according to claim 2, wherein both the bottom surfaces of the resting houses and the resting ledge are provided with a heating mechanism, wherein the heating mechanism is connected with a temperature control switch.

4. The multifunctional cat condo according to claim 3, wherein the heating mechanism is a heating filament, and the heating filament is coated in the cotton coated on the bottom surfaces of the resting houses and the resting ledge.

5. The multifunctional cat condo according to claim 1, wherein the bottom of the resting ledge is connected with a funny article through an elastic rope, and the funny article is located above the resting house in the bottom layer.
